(19) United States
(12) Patent Application Publication
(10) Pub. No.: US 2016/0012254 A1
(43) Pub. Date: Jan. 14, 2016

(54) APPARATUS, A METHOD AND MACHINE READABLE INSTRUCTIONS FOR CONTROLLING PERFORMANCE OF A PROCESS IN RESPONSE TO A DETECTED PROCESSING EVENT

(71) Applicants: RON-MICHAEL BAR, RAMAT-HASHARON (IL); ERAN GLICKMAN, RISHON LE ZION (IL); AMIR DAVID MODAN, OMER (IL)

(72) Inventors: RON-MICHAEL BAR, RAMAT-HASHARON (IL); ERAN GLICKMAN, RISHON LE ZION (IL); AMIR DAVID MODAN, OMER (IL)

(73) Assignee: FREESCALE SEMICONDUCTOR, INC., Austin, TX (US)

(21) Appl. No.: 14/325,843

(22) Filed: Jul. 8, 2014

(51) Int. Cl. G06F 21/75

(52) U.S. Cl. CPC G06F 21/75

(57) ABSTRACT

An apparatus including: circuitry configured to enable a delay of a process performed responsive to a detected processing event; and an configuration interface configured to enable pre-configuration by a user of at least one of one or more attributes of the delay, the process or the processing event.

### FIELD OF THE INVENTION

This invention relates to an apparatus and a method for controlling performance of a process in response to a detected processing event.

### BACKGROUND OF THE INVENTION

It is often the case that an apparatus, and in particular a processing apparatus, is configured to operate in a reliable and deterministic way by performing particular processes in response to particular processing events.

However, while it is desirable for an apparatus to operate in a reliable and deterministic way, it may be undesirable for a user of the apparatus to easily use this reliability and determinism to understand how the apparatus works. Such an understanding may be used for undesirable purposes such as hacking, reverse engineering or copying.

### SUMMARY OF THE INVENTION

The present invention provides an apparatus and a method as described in the accompanying claims.

Specific embodiments of the invention are set forth in the dependent claims. These and other aspects of the invention will be apparent from and elucidated with reference to the embodiments described hereinafter.

### BRIEF DESCRIPTION OF THE DRAWINGS

Further details, aspects and embodiments of the invention will be described, by way of example only, with reference to the drawings. In the drawings, like reference numbers are used to identify like or functionally similar elements. Elements in the figures are illustrated for simplicity and clarity and have not necessarily been drawn to scale.

FIG. 1 shows a block diagram of an example of an apparatus for performing a process in response to a detected processing event, after a delay.

FIG. 2 shows a flowchart of an example of a method performed by the apparatus in response to a detected processing event.

FIG. 3 shows a flowchart of another example of a method performed by the apparatus in response to a detected processing event.

FIG. 4 shows a timing diagram of an example of a timer delaying a process performed responsive to a detected processing event.

FIG. 5 shows a state diagram of an example of a state machine for a hidden timer.

FIG. 6 shows a state diagram of an example of a state machine for an unhidden timer.

FIG. 7 shows a state diagram of an example of a state machine, for a hidden timer, with a Logging state.

FIG. 8 shows a state diagram of an example of a state machine, for a hidden timer, with an Interrupt state.

FIG. 9 shows a block diagram of a particular example of an apparatus.

FIG. 10 shows a flow chart of an example of a method for changing modes.

FIG. 11 shows an example of the apparatus implemented on an integrated circuit.

FIG. 12 shows an example of a data carrier on which a set of machine readable instructions is stored.

### DETAILED DESCRIPTION OF THE PREFERRED EMBODIMENTS

Because the illustrated embodiments of the present invention may, for the most part, be implemented using electronic components and circuits known to those skilled in the art, details will not be explained in any greater extent than that considered necessary for the understanding and appreciation of the underlying concepts of the present invention and in order not to obfuscate or distract from the teachings of the present invention.

The block diagrams in the figures illustrate respective examples of an apparatus 10 which comprises delay control circuitry 20 configured to control a delay 32 with which a process 34 is performed in response to the detection of a predetermined type of processing event 30; and an configuration interface 22 configured to enable pre-configuration by a user of at least one of one or more attributes of the delay 32, the process 34 or the processing event 30. This enables obscuring, at least to a certain extent, the temporal relationship between cause (detected processing event 30) and effect (process 34) by introducing a delay 32 between the cause and effect. This helps frustrate a user hacking the apparatus 10 or hacking a device, for example an integrated circuit, hosting the apparatus 10 as a module. This obscuring may be improved, in some but not necessarily all embodiments, by introducing an element of randomness to the duration of the delay 32. The obscuring may be further improved, in some but not necessarily all embodiments, by hiding the fact that a delay has been created. In some but not necessarily all embodiments this may be achieved by creating a hidden timer 40. In some but not necessarily all embodiments the timer 40 is a hardware managed timer.

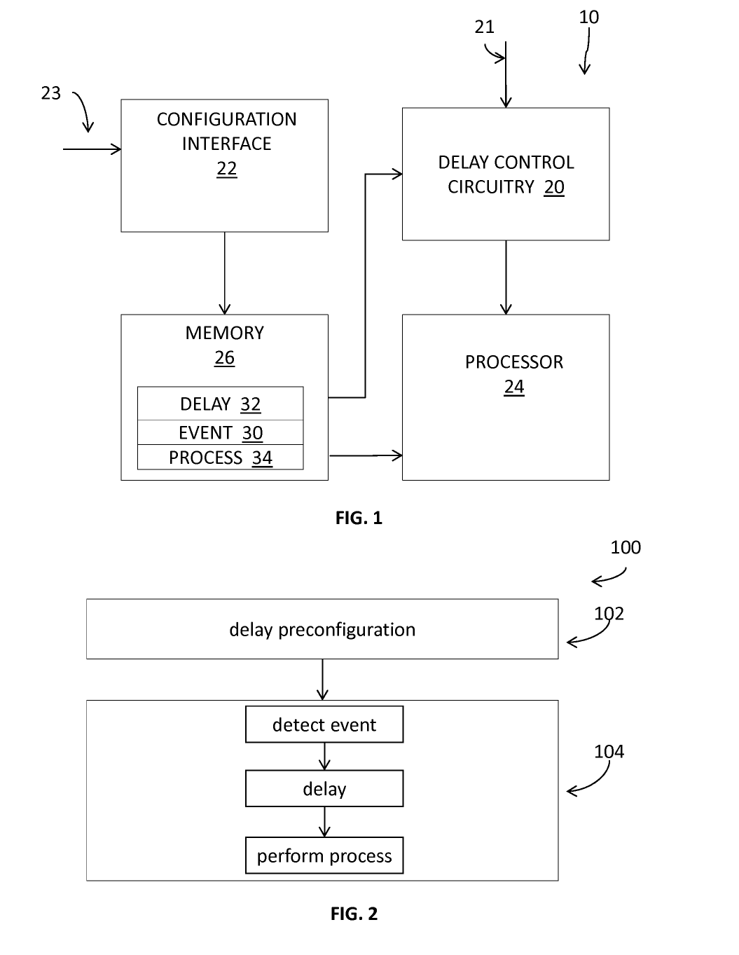

FIG. 1 illustrates an example of an apparatus 10 for performing a process 34 in response to a detected processing event 30. The process 34 is performed with (after) a delay 32. The apparatus 10 comprises delay control circuitry 20 configured to control the delay 32 with which the process 34 is performed by a processor 24 responsive to a detected processing event 30 and an configuration interface 22 via which a user set a pre-configuration by, i.e. configuration that occurs before detection of the processing event 30, e.g. by storing appropriate data in memory 26. For example, the processor 24 may be arranged to perform the process 34 in response to receiving a notification that the event 30 is detected.

In one embodiment, the pre-configuration configures one or more attributes of the delay 32 that is to be (e.g. configures it duration). In another embodiment, the pre-configuration configures the process 34 that is to be performed. In a further embodiment, the pre-configuration configures the processing event 30 that is to be detected. In a still further embodiment, the pre-configuration configures the process 34 and/or the processing event 30 and/or one or more attributes of the delay 32.

When the apparatus is in operation, the delay control circuitry 20, in response to receiving an indication 21 of a detected processing event, compares the detected processing event against one or more pre-configured processing events 30. In some but not necessarily all embodiments all, some or none of the pre-configured processing events 30 have been user configured via the configuration interface 22. However, in some but not necessarily all embodiments, processing events 30 may be enabled by default or fuse programmable. If there is a match between the detected processing event and a pre-configured processing event 30, then the delay control circuitry 20 controls processor 24 to perform the pre-configured process 34 associated with that preconfigured processing event 30 after a period of time corresponding to the pre-configured delay 32 set for the detected type of event. Thus, the separation in time between the point in time the indication 21 of a detected processing event is received and the performance of the process 34 is determined by the pre-configured delay 32.

The pre-configured delay may be any delay suitable for the specific implementation, and e.g. be fixed or variable, and for example be determined dynamically in real-time or pre-determined. In some but not necessarily all embodiments, the delay 32 may have a duration of random length. In some but not necessarily all embodiments, the delay 32 may be variable between a minimum duration and/or a maximum duration. The pre-configured attributes of the delay 32 may for example include:

whether or not the delay 32 has a random duration;

the minimum duration of the delay 32 (if any); and

the maximum duration of the delay 32 (if any).

As an example, the minimum delay may be a value between 1 micro-second and 10 micro-seconds. As an example, the maximum delay may be a value between hours and days length of monitoring time. If the delay 32 has duration of random length, then successively used delays 32 in respect of the same detected event 30 will have durations that have a random or pseudo random relationship.

In some but not necessarily all embodiments pre-configuration by a user of the process 34 comprises identification of the process, for example by selection from a list. In some but not necessarily all embodiments pre-configuration by a user of the process 34 comprises programming by a user of the process 34. In some but not necessarily all embodiments the process 34 comprises reporting a pre-defined process identifier that enables an identified process to be performed. In some but not necessarily all embodiments the process 34 comprises reporting a log recorded during the delay 32.

In some, but not necessarily all embodiments, the processing event 30 is a security breach event. This is an event that occurs when an attempted or actual breach of security is detected, e.g. a tampering event such as an attempt to have unauthorized access to a protected part of a memory, e.g. in which encryption keys or other secured information is stored, or other event indicating an attempt to breach security of the system.

FIG. 2 illustrates an example of a method 100 performed by the apparatus 10. The method 100 is a method for performing a process 34 in response to a detected processing event 30. The process 34 is performed in response to a detected processing event 30 after a delay 32. As shown with block 102, prior to, and separate, from the other parts of the method, pre-configuration enables pre-configuration by a user of at least one of one or more attributes of the delay 32 that is to be used, the processing event 30 that is to be detected; and the process 34 that is to be performed.

As shown with block 104, an event may be detected and be verified to be of a type associated with a delay. If a delay is associated with the type of the detected, the process associated with the event is performed with a delay corresponding to what has been pre-configured. There is therefore a delay 32 between when the processing event 30 is detected and when the process 34 associated with that detected processing event 30 is performed. The delay 32 may be significant and measureable.

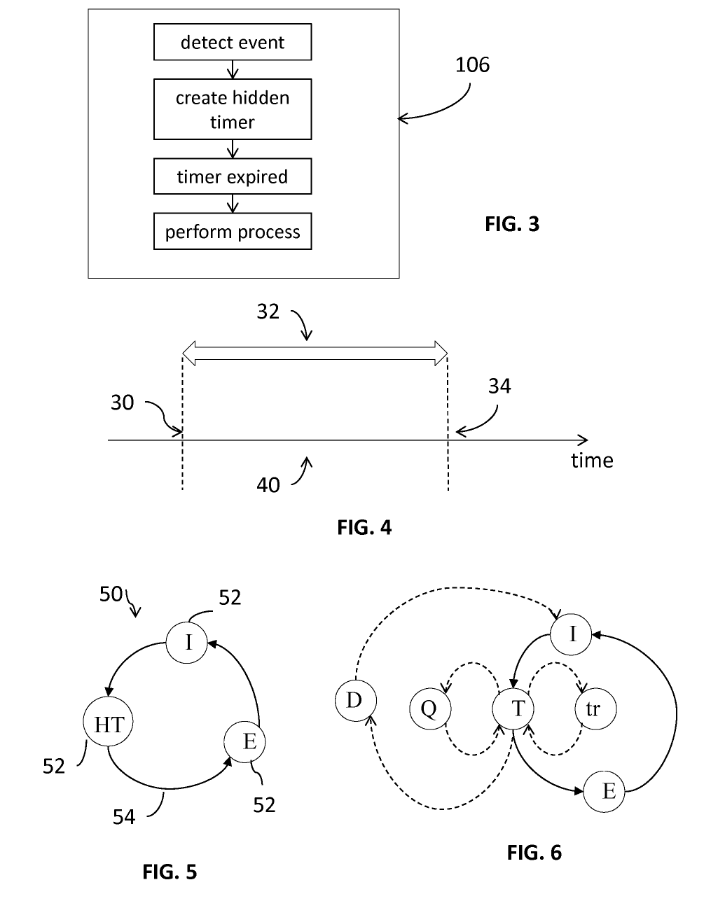

FIG. 3 illustrates with an alternative block 106 that the method may, in some but not necessarily all embodiments, comprises creation of a, hidden, timer 40 and performance of the process in response to expiration of the timer. This may be performed by delay control circuitry 20. The creation of the timer 40 enables the delay 32 of the process 34 performed responsive to the detected processing event 30, as illustrated in FIG. 4. In some but not necessarily all embodiments the use of and/or the duration of the delay 32 may be hidden. In this case, the timer 40 may have particular attributes that render it hidden.

FIG. 5 illustrates an example of a state machine 50 for a hidden timer 40. Operation of the created hidden timer 40 is defined by the state machine 50. The state machine 50 comprises a first plurality of states 52 and a second plurality of transitions 54 between states. The states include: an Idle state I that represents a state before creation of the hidden timer 40, an Active Timer state HT that represents a state when the timer is active and hidden; and an Expired state E that represents a state when the hidden timer 40 expires.

When the hidden timer 40 is created the state machine 50 transitions from the Idle state I to the Active Timer state HT. This transition may provide the random duration count (delay 32) for that timer 40. As previously described, this transition occurs when there is a match between a received detected processing event and the pre-configured processing event 30. The hidden timer 40 expires after the pre-configured delay 32. The hidden timer 40 remains in the Active Timer state HT until the timer expires after the delay 32. The state machine 50 then transitions from the Active Timer state HT to the Expired state E. When the hidden timer 40 enters the Expired state E, the pre-configured process 34 is performed. The state machine 50 then transitions back to the Idle state I.

It will be appreciated that all of the transitions of the state machine 50 for the hidden timer 40 illustrated in FIG. 5 are system transitions that are initiated or caused by the system and are not user transitions initiated or caused by a user. The transitions are as a consequence of matching a received detected event and a pre-configured event 30, the expiry of the hidden timer 40 and the performance of the process 34.

FIG. 6 illustrates an example of a state machine for an unhidden timer 40. In addition to the states described with reference to FIG. 5, it has one or more of the following user caused states:

a Query state Q that allows a user to query the unhidden timer;

a Delete state D that allows a user to delete the unhidden timer;

a Trace state tr that allows a user to trace the unhidden timer.

The active timer state is denoted T (not HT) to emphasise that it is not hidden.

The Query state Q and the Trace state tr do not interfere with the operation of the timer. TA transition to these states results in the provision of information to a user followed by a transition of the state machine back to the active timer state T.

The Query state Q is entered when the user queries a particular timer. The information provided may, for example, be an expiry time for the particular timer or some other attribute(s) of the particular timer such as what occurs when it expires.

The Trace state tr is entered when the user searches for a timer that matches a particular attribute. The information provided may, for example, be an expiry time for the timer that matches that particular attribute or some other attribute(s) of the matching timer such as what occurs when it expires.

It will be noticed that the transitions to and from the user caused states (D, Q, tr) are indicated in the state machine using dotted lines to emphasize that they are user initiated or caused transitions. The system caused or initiated transitions are indicated using solid lines.

It will be appreciated by comparing the state machines of FIGS. 5 and 6 that the illustrated example of the state machine 50 for a hidden timer 40 does not have any user caused or initiated transitions and does not have a Query state or a Trace state tr or a Delete state D. The hidden timer 40 in this example cannot therefore be queried via a user command and can only provide a system output and cannot provide a user output.

It will also be appreciated from the state machine 50 for the hidden timer 40 that in at least some embodiments the delay control circuitry 20 is configured to enable autonomously the delay 32 of the process 34 performed responsive to the detected processing event 30 by autonomously creating the hidden timer 40.

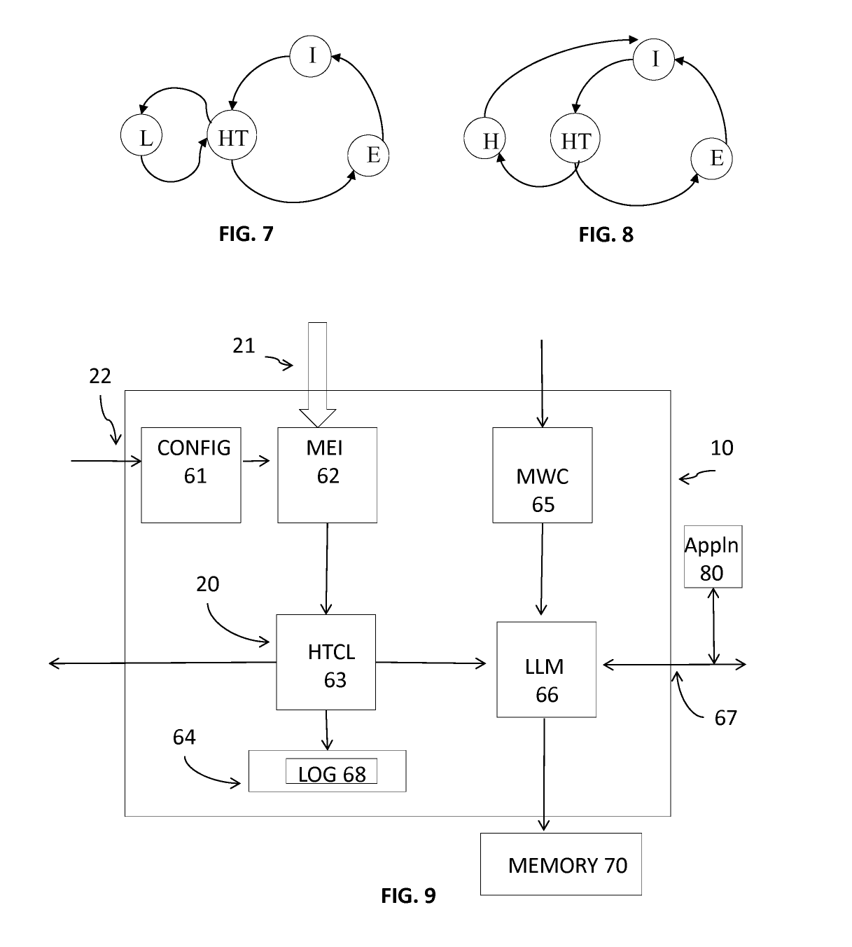

FIG. 7 illustrates an example of a state machine for a hidden timer 40. In addition to the states described with reference to FIG. 5 it additionally has a Logging state L. The Logging state L is entered from the active Timer state HT when a particular event or events occur. The event(s) may, for example, be security breach event(s). The Logging state L results in the delay control circuitry 20 storing a record of the event in a log 68. The state machine 50 then transitions back to the active Timer state HT. The delay control circuitry 20 is thus configured to store events in the log 68 as they occur. The log 68 may be stored in a secure, non-volatile memory. The Logging state L does not interfere with the operation of the timer 40. The process 34 that is performed after the delay 32 on expiry of the hidden timer 40 may, in this circumstance, comprise reporting the log 68 recorded during the delay 32 to an application or operating system.

FIG. 8 illustrates an example of a state machine for a hidden timer 40. In addition to the states described with reference to FIG. 5 (or FIG. 7) it additionally has an Interrupt state H. The Interrupt state H is entered from the active Timer state HT when a particular critical event or critical events occur. The critical events may, for example, be fatal security breach events. The Interrupt state H results in a transition of the state machine back to the Idle state I. The Interrupt state I may stop operation of the timer 40 and the performance of an interrupt procedure by an application or operating system.

FIG. 9 illustrates a further example of an apparatus 10. The apparatus 10 implements a time keeping solution (TKS) that uses a memory 70 to provide one or more active timers. The apparatus 10 comprises delay control circuitry 20 configured to enable a delay 32 of a process 34 performed responsive to a detected security breach event 30 by creating a hidden timer 30 and an configuration interface 22 configured to enable pre-configuration by a user of the state machine 50 associated with the hidden timer.

A configuration module 61 is configured to receive input via the user configuration interface 22 from a system host. The configuration module 61 may be configured to enable pre-configuration by a user of the state machine 50 associated with the hidden timer. The pre-configuration may for example pre-configure the detected security breach event that transitions the state machine 50 from the idle state to the active timer state HT. The pre-configuration may for example pre-configure the delay 32 that transitions the state machine 50 from the active timer state HT to the timer Expired state E. The pre-configuration may for example pre-configure the process 34 that is performed when the state machine 50 transitions to the timer Expired state E.

A Master Event Indicator (MEI) will create an alert when a security breach event, as indicated with arrow 21, is detected by a Security Monitor or SM (not illustrated) which matches the pre-configured security breach event 30. The delay control circuitry 20 is provided in the form of a Hidden Timer Creation Logic (HTCL), which receives the alert from the MEI 62. The HTCL enables creation of a new hidden timer 40 with a random expiration time in the future. The hidden timer 40 is not related to any currently running process.

The random timer duration (delay 32) is provided by the HTML to a Link Lists Manager (LLM) 66. The LLM 66 creates the hidden timer 40 by placing an entry for the hidden timer 40 in its functional link list, stored in memory 70. The memory 70 is configured, under the control of the LLM 66 to provide one or more active timers that expire at future times including at least one hidden timer 40. A free running clock 65 generates a n-bits wide counter. The clock 65 in this example is a Master Wall Clock (MWC). The clock 65 provides input to the LLM 66. The clock is used to determine when a hidden timer 40 expires.

The HTCL 63 may configured to store information about security breach events received from the MEI 62 in the log 68 which is stored as they occur. In some but not necessarily all examples, the log 68 may be stored in a battery operated domain. The battery operated domain may, for example, comprise an always-on volatile memory. In some but not necessarily all examples, the log 68 may be stored in a secure non-volatile memory 64. The LLM 66 may be configured to enable provision of the log 68 to an application 80 or operating system when the hidden timer 40 expires after the delay 32. The log 68 may be used by the application 80 or operating system to disambiguate a user hack from a user error.

The circuitry that is used for hidden timers may be also be used for unhidden timers. In some but not necessarily all embodiments of the apparatus 10, the memory 70 is configured, under the control of the LLM 66, to provide a plurality of active timers that expire at future times including hidden timers created by the delay control circuitry 20 and unhidden timers. The LLM 66 operates as a timer query system. It is operational to produce a report in response to a query for unhidden timers but not hidden timers. The timer query system comprises:

a timer (query) interface 67 configured to receive a timer query;

timer access circuitry 66 configured to access the timer circuitry 70 to obtain information for an active timer relating to a received timer query; and

a timer (report) interface 67 configured to produce a report comprising the obtained information.

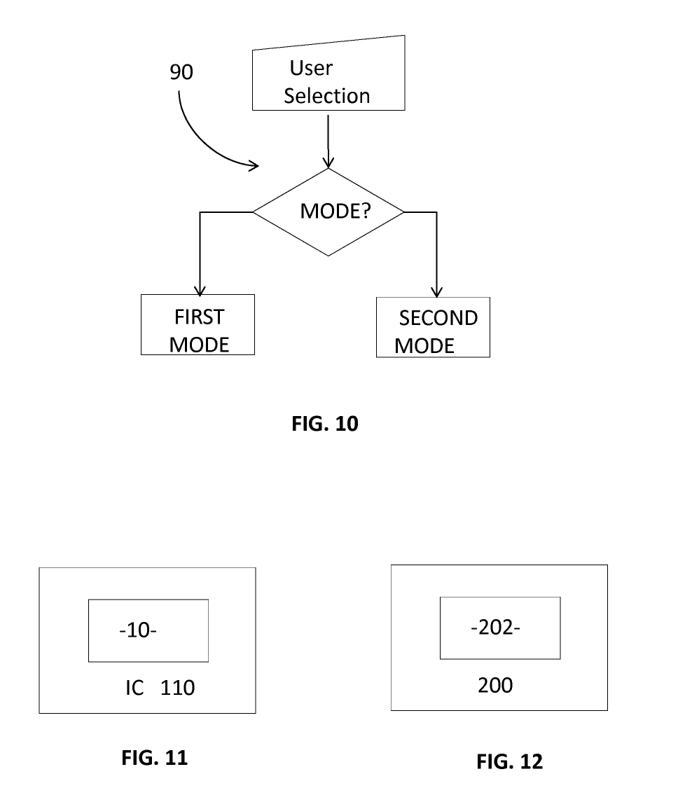

FIG. 10 illustrates an example of a method 90 for changing modes. The method 90 may be used in some but not necessarily all embodiments of the apparatus 10 to enable user or system control of the modes. When the apparatus 10 operates in a first mode, the process 34 is performed responsive to the detected processing event 30 without any delay. The delay control circuitry 20, when operating in the first mode, does not enable creation of a hidden timer and the process 34 is performed immediately in response the detected event 30.

When the apparatus 10 operates in a second mode, the process 34 is performed responsive to a detected processing event 30 after the delay 32. The delay control circuitry 20 when operating in the second mode enables creation of a hidden timer 40 and the process 34 is performed in response the detected event 30 after a delay determined by the hidden timer 40

The configuration interface 22 may be configured to enable pre-configuration by a user of whether the delay control circuitry 20/apparatus 10 operates in the first mode or operates in the second mode.

FIG. 11 illustrates an example of the apparatus 10 implemented as an integrated circuit (IC) 110. The integrated circuit 110 may, for example, be formed using photolithography on a monolithic semiconductor substrate, and comprise one or more dies in a common package. In one embodiment, apparatus 10 is an integrated circuit data processing device, for example a microprocessor, such as a general purpose microprocessor, a microcontroller, a digital signal processor or other suitable type of System on a Chip (SoC). The microprocessor may for example comprise one, two or more central processing units (CPU) or cores. Additionally, the microprocessor may comprise one or more peripherals, such as hardware accelerators, co-processors or otherwise, and/or memory, such as on-chip flash or RAM.

In the foregoing specification, the invention has been described with reference to specific examples of embodiments of the invention. It will, however, be evident that various modifications and changes may be made therein without departing from the scope of the invention as set forth in the appended claims and that the examples are merely illustrative.

For example, the connections or interfaces may be a type of connection suitable to transfer signals from or to the respective nodes, units or devices, for example via intermediate devices. Accordingly, unless implied or stated otherwise the connections may for example be direct connections or indirect connections. The conductors or interfaces as discussed herein may be illustrated or described in reference to being a single conductor or interface, a plurality of conductors or interfaces, unidirectional conductors or interfaces, or bidirectional conductors or interfaces. However, different embodiments may vary the implementation of the conductors or interfaces. For example, separate unidirectional conductors/interfaces may be used rather than bidirectional conductors/interfaces and vice versa. Also, plurality of conductors/interfaces may be replaced with a single conductor/interface that transfers multiple signals serially or in a time multiplexed manner. Likewise, single conductors/interface carrying multiple signals may be separated out into various different conductors/interfaces carrying subsets of these signals. Therefore, many options exist for transferring signals.

Some of the above embodiments, as applicable, may be implemented using a variety of different information processing systems. For example, although FIGS. 1 and 9 and the discussion thereof describe exemplary information processing architectures, these exemplary architectures are presented merely to provide a useful reference in discussing various aspects of the invention. Of course, the description of the architecture has been simplified for purposes of discussion, and it is just one of many different types of appropriate architectures that may be used in accordance with the invention. Those skilled in the art will recognize that the boundaries between logic blocks are merely illustrative and that alternative embodiments may merge logic blocks or circuit elements or impose an alternate decomposition of functionality upon various logic blocks or circuit elements.

Thus, it is to be understood that the architectures depicted herein are merely exemplary, and that in fact many other architectures can be implemented which achieve the same functionality. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Also for example, in one embodiment, the illustrated elements of apparatus 10 are circuitry located on a single integrated circuit or within a same device. Alternatively, apparatus 10 may include any number of separate integrated circuits or separate devices interconnected with each other. For example, memory 70 may be located on a same integrated circuit as delay control circuitry 20 or on a separate integrated circuit or located within another peripheral or slave discretely separate from other elements of apparatus 10.

Furthermore, those skilled in the art will recognize that boundaries between the functionality of the above described operations are merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The use of the term ‘example’ or ‘for example’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’ or ‘may’ refers to a particular instance in a class of examples. A property of the instance can be a property of only that instance or a property of the class or a property of a sub-class of the class that includes some but not all of the instances in the class. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

1. An apparatus, comprising:
circuitry configured to enable a delay of a process performed responsive to a detected processing event; and
a configuration interface configured to enable pre-configuration by a user of at least one of one or more attributes of the delay, the process or the processing event.

2. An apparatus as claimed in claim 1, implemented as or part of a system on a chip.

3. An apparatus as claimed in claim 1, wherein the circuitry is configured to create a hardware timer in response to detecting the detected processing event.

4. An apparatus as claimed in claim 3, wherein the timer is hidden.

5. An apparatus as claimed in claim 3, wherein the circuitry is configured to enable creation of a timer that is independent of any currently running process.

6. An apparatus as claimed in claim 3, wherein the circuitry is configured to enable creation of a timer that cannot be queried via a user command.

7. An apparatus as claimed in claim 3, wherein the circuitry is configured to enable creation of a timer that can only provide a system output and cannot provide a user output.

8. An apparatus as claimed in claim 3, wherein operation of the created timer is defined by a state machine that comprises a first plurality of states and a second plurality of transitions between states, wherein all of the second plurality of transitions are system enabled transitions as opposed to user enabled transitions.

9. An apparatus as claimed in claim 1, wherein an attribute of the delay is whether or not a duration of the delay is random and/or a constraint on a maximum or minimum duration of the delay.

10. An apparatus as claimed in claim 1, wherein pre-configuration by a user of the process comprises identification and/or programming of the process.

11. An apparatus as claimed in claim 1, wherein the process comprises reporting a pre-defined process identifier.

12. An apparatus as claimed in claim 1, wherein the process comprises reporting a log recorded during the delay.

13. An apparatus as claimed in claim 1, wherein the processing event is a security breach event.

14. An apparatus as claimed in claim 12, wherein the log is a log of security breach events.

15. An apparatus as claimed in claim 12, wherein the circuitry is configured to provide the log to an application that disambiguates a user hack from a user error.

16. An apparatus as claimed in claim 1, wherein the circuitry is configured to enable autonomously the delay of the process performed responsive to the detected processing event.

17. An apparatus as claimed in claim 1, comprising:
timer circuitry configured to provide a plurality of active timers that expire at future times including hidden timers created by the circuitry and unhidden timers; and
a timer query system, operational to produce a report in response to a query for unhidden timers but not hidden timers, comprising:
a timer query interface configured to receive a timer query;
timer access circuitry configured to access the timer circuitry to obtain information for an active timer relating to a received timer query; and
a timer report interface configured to produce a report comprising the obtained information.

18. An apparatus as claimed in claim 1, wherein the configuration interface is configured to enable configuration by a user of whether the circuitry operates in a first mode or operates in a second mode.

19. An apparatus as claimed in claim 1, implemented on an integrated circuit.

20. A method comprising:
enabling pre-configuration by a user of at least one of one or more attributes of a delay, a process or a processing event; and
causing the delay of the process performed responsive to the detected processing event.
